(19) United States
(12) Patent Application Publication
(10) Pub. No.: US 2004/0001471 A1
(43) Pub. Date: Jan. 1, 2004

(54) Card device for wireless data communication

(76) Inventors: Eun-Bok Lee, Seongnam-Si (KR); Jeong-Hyun Seo, Seoul (KR)

Correspondence Address: CANTOR COLBURN LLP, 55 Griffin South Road, Bloomfield, CT, 06002, US

(21) Appl. No.: 10/284,951

(22) Filed: Oct. 31, 2002

(30) Foreign Application Priority Data
Nov. 28, 2001 (KR) 2001-74609

(51) Int. Cl. H04Q 7/24

(52) U.S. Cl. 370/338; 370/419

(57) ABSTRACT

A card device for wireless data communication. The card device comprises a wireless LAN (Local Area Network) module for performing data communication over a wireless LAN, the wireless LAN module including a first PCMCIA (Personal Computer Memory Card International Association) interface, a mobile communication module for performing wireless data communication over a mobile communication network, the mobile communication module including a serial communicator and a universal interface bus, a second PCMCIA interface for performing interfacing with a computer according to a PCMCIA protocol, a signal selector for converting a format of output data from the mobile communication module into a PCMCIA format and selectively connecting one of the mobile communication module and wireless LAN module to the second PCMCIA interface, and a controller for controlling an operation of the signal selector. The present card device is capable of performing a CDMA wireless data communication method and a wireless LAN data communication method in a single terminal.

### BACKGROUND OF THE INVENTION

1. Field of the Invention

The present invention relates to a card device for wireless data communication.

2. Description of the Related Art

A mobile communication terminal, such as a portable computer or personal digital assistant (PDA), is conventionally adapted to transmit and receive data wirelessly using a CDMA (Code Division Multiple Access) mobile communication method, a wireless LAN (Local Area Network) communication method, an infrared communication method or etc.

The CDMA method has an advantage in that wireless data communication can be performed over long distances to far-away regions through the use of national network facilities. The wireless LAN method is advantageous in that a network usage fee is low and data is transferred at a high data rate of 11 Mbps.

However, the CDMA method is disadvantageous in that a network usage fee is high and data is transmitted and received at a lower data rate of 144 Kbps˜2 Mbps than that of the wireless LAN method, resulting in inconvenience to a user.

Moreover, the wireless LAN method has a disadvantage in that data can be transmitted and received only within a limited range, namely, the data transmission/reception is subject to limitations in distance and region.

Furthermore, a conventional wireless data communication user has to separately use a wireless data communication card containing a mobile communication module of a CDMA type and a wireless data communication card containing a wireless LAN module of a wireless LAN type, resulting in an increased economic burden.

### SUMMARY OF THE INVENTION

Therefore, the present invention has been made in view of the above problems, and it is an object of the present invention to provide a card device for wireless data communication which contains a wireless LAN module and mobile communication module in an integrated manner, thereby performing a CDMA wireless data communication method and a wireless LAN data communication method in a single terminal.

In accordance with the present invention, the above and other objects can be accomplished by the provision of a card device for wireless data communication, comprising: a wireless LAN (Local Area Network) module for performing data communication over a wireless LAN, the wireless LAN module including a first PCMCIA (Personal Computer Memory Card International Association) interface; a mobile communication module for performing wireless data communication over a mobile communication network, the mobile communication module including a serial communicator and a universal interface bus; a second PCMCIA interface for performing interfacing with a computer according to a PCMCIA protocol; a signal selector for converting a format of output data from the mobile communication module into a PCMCIA format and selectively connecting one of the mobile communication module and wireless LAN module to the second PCMCIA interface; and a controller for controlling an operation of the signal selector.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a card device for wireless data communication in accordance with the present invention;

FIG. 2 is a block diagram showing the construction of a signal selector in accordance with a preferred embodiment of the present invention; and

FIG. 3 is a block diagram showing the construction of the signal selector in accordance with an alternative embodiment of the present invention.

### DESCRIPTION OF THE PREFERRED EMBODIMENTS

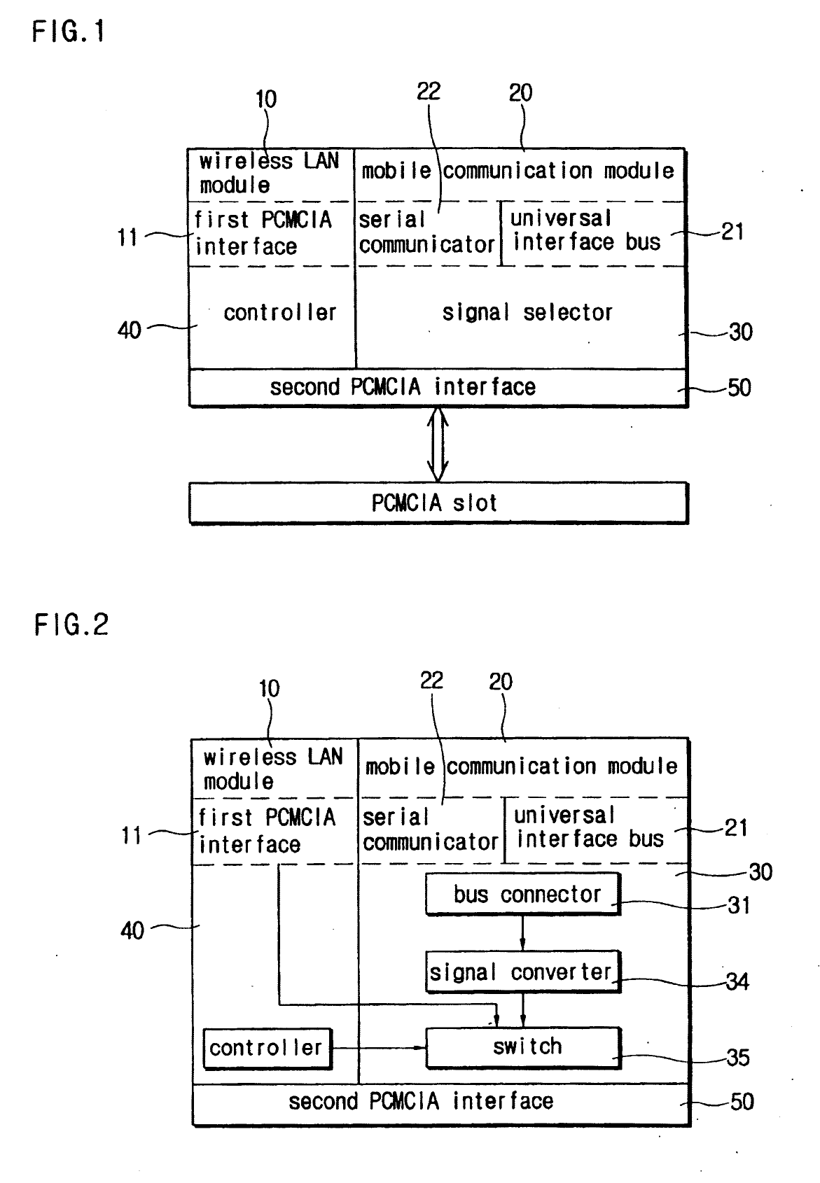

With reference to FIG. 1, there is shown in block form the construction of a card device for wireless data communication in accordance with the present invention.

As shown in FIG. 1, the wireless data communication card device according to the present invention comprises a wireless LAN module 10 including a first PCMCIA (Personal Computer Memory Card International Association) interface 11, a mobile communication module 20, a signal selector 30, a controller 40, and a second PCMCIA interface 50.

The first PCMCIA interface 11 of the wireless LAN module 10 acts to convert the format of external data transmitted thereto into a PCMCIA format.

The wireless LAN module may be, for example, an ISL 3873 chip commercially available from Intersil(TM) Corporation, which is well known to those skilled in the art and a detailed description of which will thus be omitted.

The mobile communication module 20 includes a universal interface bus 21 and a serial communicator 22.

The serial communicator 22 functions to transfer data processed by a CDMA processor to a portable computer or PDA coupled with the card device of the present invention. To this end, the serial communicator 22 includes a UART (Universal Asynchronous Receiver/Transmitter) serial communicator and a USB (Universal Serial Bus) serial communicator.

The mobile communication module 20 may be, for example, an MSM 5105 chip commercially available from Qualcom(TM) Inc., which is well known to those skilled in the art and a detailed description of which will thus be omitted.

The signal selector 30 is adapted to convert the format of output data from the mobile communication module 20 into the PCMCIA format and selectively connect one of the mobile communication module 20 and wireless LAN module 10 to the second PCMCIA interface 50.

Now, the construction of the signal selector 30 will be described in conjunction with preferred embodiments of the present invention.

FIG. 2 is a block diagram showing the construction of the signal selector 30 in accordance with a preferred embodiment of the present invention. As shown in this drawing, the signal selector 30 includes a bus connector 31, a signal converter 34 and a switch 35.

The bus connector 31 is connected to the universal interface bus 21 of the mobile communication module 20 to receive address and data signals therefrom.

The signal converter 34 acts to convert the format of output data from the universal interface bus 21 of the mobile communication module 20 into the PCMCIA format.

The bus connector 31 and signal converter 34 connected to the universal interface bus 21 of the mobile communication module 20 are preferably implemented with a dual port random access memory (RAM). The mobile communication module 20 includes a mobile communication modem with a high-speed CDMA processor (not shown) which is connected in parallel with the dual port RAM to transmit and receive address and data signals to/from the dual port RAM via the universal interface bus 21. The procedure of performing high-speed wireless data communication in a mobile communication terminal using a dual port RAM is shown in Korean Patent Application No. 10-2001-0067711 (entitled “CARD DEVICE FOR HIGH-SPEED WIRELESS DATA COMMUNICATION”), invented and filed by this inventor, and a detailed description thereof will thus be omitted.

The switch 35 acts to selectively transfer output data from the signal converter 34 and output data from the first PCMCIA interface 11 of the wireless LAN module 10 to the second PCMCIA interface 50 in response to a selection signal from the controller 40.

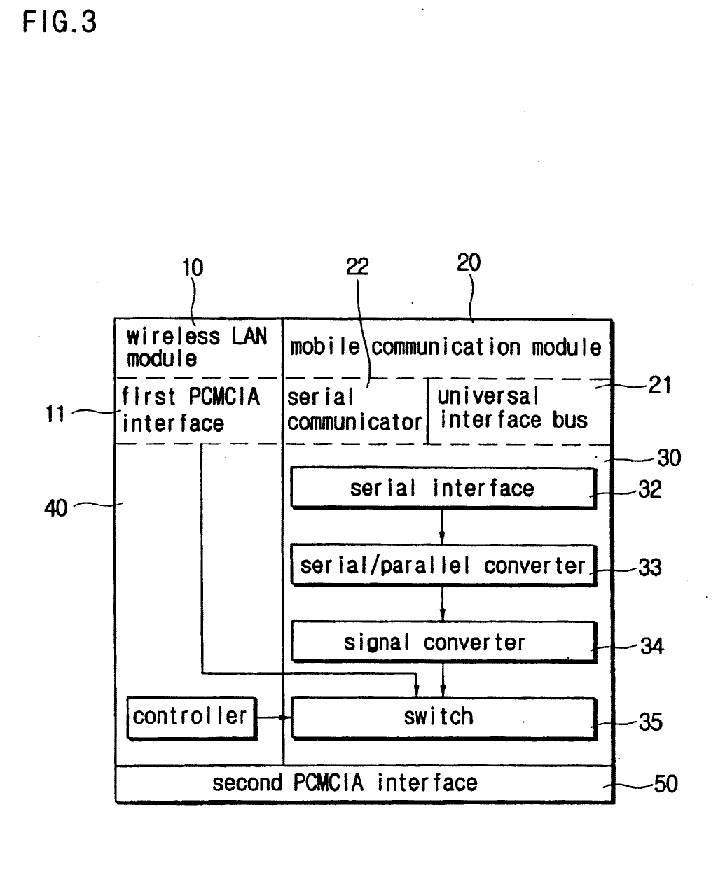

FIG. 3 is a block diagram showing the construction of the signal selector 30 in accordance with an alternative embodiment of the present invention. As shown in this drawing, the signal selector 30 includes a serial interface 32, a serial/parallel converter 33, a signal converter 34 and a switch 35.

The serial interface 32 is connected to the serial communicator 22 of the mobile communication module 20.

The serial interface 32 may be a UART interface connected to the UART serial communicator of the mobile communication module 20 or a USB interface connected to the USB serial communicator of the mobile communication module 20.

The serial/parallel converter 33 acts to convert output serial data from the serial interface 32 into parallel data.

The signal converter 34 acts to convert the format of output data from the serial/parallel converter 33 into the PCMCIA format.

The switch 35 acts to selectively transfer output data from the signal converter 34 and output data from the first PCMCIA interface 11 of the wireless LAN module 10 to the second PCMCIA interface 50 in response to a selection signal from the controller 40.

The controller 40 is adapted to output the selection signal to control the operation of the signal selector 30.

A description will hereinafter be given of the operation of the wireless data communication card device including the wireless LAN module and the mobile communication module in the integrated manner, constructed as stated above.

If the wireless data communication card device including the wireless LAN module and the mobile communication module in the integrated manner is mounted to a mobile communication terminal such as a portable computer or PDA, then the wireless data communication card device and the portable computer equipped with it perform their respective initialization operations of driving their respective device drives to conduct data communication. These initialization operations are well known to those skilled in the art and a description thereof will thus be omitted.

If the initialization operations are completed, the controller of the wireless communication card device automatically operates the wireless LAN module to detect a transmitted external signal.

If an external signal is detected, a user conducts wireless data communication over a wireless LAN using an application program.

Unless an external signal is detected, the controller of the wireless communication card device operates the mobile communication module to detect a transmitted external signal.

If an external signal is detected, the user conducts wireless data communication over a CDMA mobile communication network using an application program.

The user can select one of the wireless LAN module and mobile communication module in a device driver installed in the portable computer.

At this time, in the case where the communication module selected by the user is not suitable to the current wireless communication environment, the portable computer outputs an alarm message and advises the user to select the other communication module.

Therefore, the wireless data communication card device according to the present invention includes the CDMA wireless data communication system and the wireless LAN data communication system in the integrated manner, thereby enabling the user to conduct wireless data communication more easily and at a lower cost.

As apparent from the above description, the present invention provides a card device for wireless data communication which includes a CDMA wireless data communication system and a wireless LAN data communication system in an integrated manner, thereby solving the inconvenience of changing and inserting each wireless data communication card in a portable computer or PDA.

Further, the wireless data communication card device according to the present invention enables a user to conduct wireless data communication at a lower cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A card device for wireless data communication, comprising:
a wireless LAN (Local Area Network) module for performing data communication over a wireless LAN, said wireless LAN module including a first PCMCIA (Personal Computer Memory Card International Association) interface;
a mobile communication module for performing wireless data communication over a mobile communication network, said mobile communication module including a serial communicator and a universal interface bus;
a second PCMCIA interface for performing interfacing with a computer according to a PCMCIA protocol;
a signal selector for converting a format of output data from said mobile communication module into a PCMCIA format and selectively connecting one of said mobile communication module and wireless LAN module to said second PCMCIA interface; and
a controller for controlling an operation of said signal selector.

2. The card device as set forth in claim 1, wherein said signal selector includes:
a bus connector connected to said universal interface bus of said mobile communication module;
a signal converter for converting a format of output data from said universal interface bus of said mobile communication module into said PCMCIA format; and
a switch for selecting transferring output data from said signal converter and output data from said first PCMCIA interface of said wireless LAN module to said second PCMCIA interface in response to a selection signal from said controller.

3. The card device as set forth in claim 2, wherein said bus connector and signal converter are implemented with a dual port random access memory.

4. The card device as set forth in claim 1, wherein said signal selector includes:
a serial interface connected to said serial communicator of said mobile communication module;
a serial/parallel converter for converting output data from said serial interface into parallel data;
a signal converter for converting a format of output data from said serial/parallel converter into said PCMCIA format; and
a switch for selecting transferring output data from said signal converter and output data from said first PCMCIA interface of said wireless LAN module to said second PCMCIA interface in response to a selection signal from said controller.

5. The card device as set forth in claim 4, wherein said serial communicator of said mobile communication module includes a UART (Universal Asynchronous Receiver/Transmitter) serial communicator, said serial interface being a UART interface connected to said UART serial communicator.

6. The card device as set forth in claim 4, wherein said serial communicator of said mobile communication module includes a USB (Universal Serial Bus) serial communicator, said serial interface being a USB interface connected to said USB serial communicator.
